(19) United States
(12) Patent Application Publication
(10) Pub. No.: US 2023/0061407 A1
(43) Pub. Date: Mar. 2, 2023

(54) WIDEBAND CHANNEL ACCESS WITH MULTIPLE PRIMARY CHANNELS

(71) Applicants: Juan Fang, Portland, OR (US); Minyoung Park, San Ramon, CA (US)

(72) Inventors: Juan Fang, Portland, OR (US); Minyoung Park, San Ramon, CA (US)

(21) Appl. No.: 17/983,793

(22) Filed: Nov. 9, 2022

Related U.S. Application Data
(60) Provisional application No. 63/347,489, filed on May 31, 2022.

(51) Int. Cl. H04W 72/04

(52) U.S. Cl. CPC H04W 72/04

(57) ABSTRACT

An access point station (AP) configured for wideband channel operation may communicate with non-access point stations (STAs) over channel bandwidths that include one or more primary channels. For channel bandwidths that include more than one primary channel, the AP may communicate with the STAs within those channel bandwidths even though the NAV of one of the primary channels within the channel bandwidth has not expired. In these embodiments, the AP does not need to wait for the NAV of a primary channel to expire to transmit a wideband transmission when another primary channel is the channel bandwidth is available.

This application claims the benefit of priority under 35 U.S.C. 119(e) to U.S. Provisional Patent Application Ser. No. 63/347,489, filed May 31, 2022, which is incorporated herein by reference in its entirety.

### TECHNICAL FIELD

Embodiments pertain to wireless communications. Some embodiments relate wireless local area networks (WLANs) that operate in accordance with the IEEE 802.11 standards. Some embodiments relate to IEEE 802.11be Extremely High Throughput (EHT) (i.e., the IEEE P802.11-Task Group BE EHT) (Wi-Fi 7). Some embodiments relate to Wi-Fi 8.

### BACKGROUND

One issue with communicating data over a wireless network is efficient utilization of channel resources. For Wi-Fi 8, important technical topics are wideband channel operation and multi-link operation. One issue with wideband channel operation is that a station cannot transmit a wideband transmission until the primary channel becomes idle. As a result, throughput is degraded.

Thus, what are needed are apparatus, systems and methods for wideband transmission with improved throughput.

### BRIEF DESCRIPTION OF THE DRAWINGS

FIG. 1 is a block diagram of a radio architecture, in accordance with some embodiments.

FIG. 2 illustrates a front-end module circuitry for use in the radio architecture of FIG. 1, in accordance with some embodiments.

FIG. 3 illustrates a radio IC circuitry for use in the radio architecture of FIG. 1, in accordance with some embodiments.

FIG. 4 illustrates a baseband processing circuitry for use in the radio architecture of FIG. 1, in accordance with some embodiments.

FIG. 5 illustrates a WLAN, in accordance with some embodiments.

FIG. 6 illustrates a multi-link framework in accordance with some embodiments.

FIG. 7A, FIG. 7B and FIG. 7C illustrate wideband channel access in accordance with some embodiments.

FIG. 8 is a procedure for wideband channel operation, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

An access point station (AP) configured for wideband channel operation may communicate with non-access point stations (STAs) over channel bandwidths that include one or more primary channels. For channel bandwidths that include more than one primary channel, the AP may communicate with the STAs within those channel bandwidths even though the NAV of one of the primary channels within the channel bandwidth has not expired. In these embodiments, the AP does not need to wait for the NAV of a primary channel to expire to transmit a wideband transmission when another primary channel is the channel bandwidth is available. These embodiments as well as others, are discussed in more detail below.

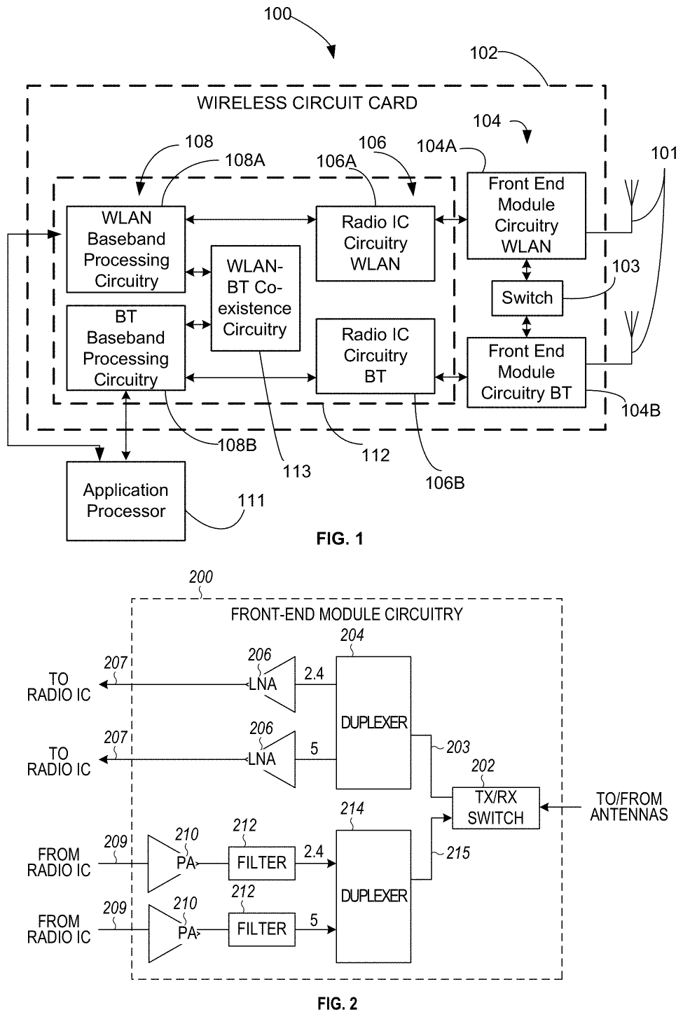

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal sub carriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE 802.11ax, and/or IEEE P802.11be standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE 802.11be standard. In these embodiments, the radio architecture 100 may be configured to communicate in accordance with an OFDMA technique, although the scope of the embodiments is not limited in this respect. In some embodiments, the radio architecture 100 may be configured for next generation vehicle-to-everything (NGV) communications in accordance with the IEEE 802.11bd standard and one or more stations including AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards.

In some embodiments, the radio-architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

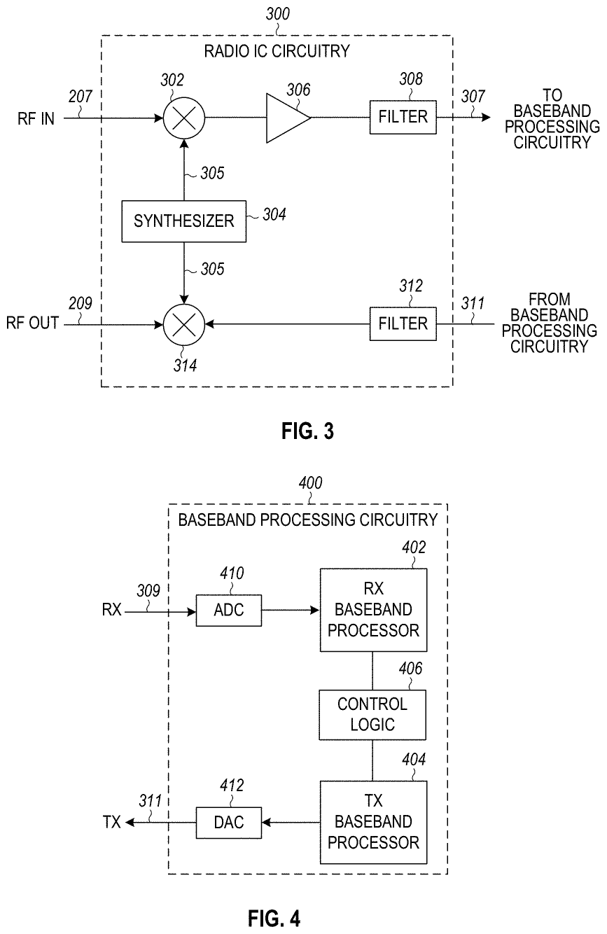

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

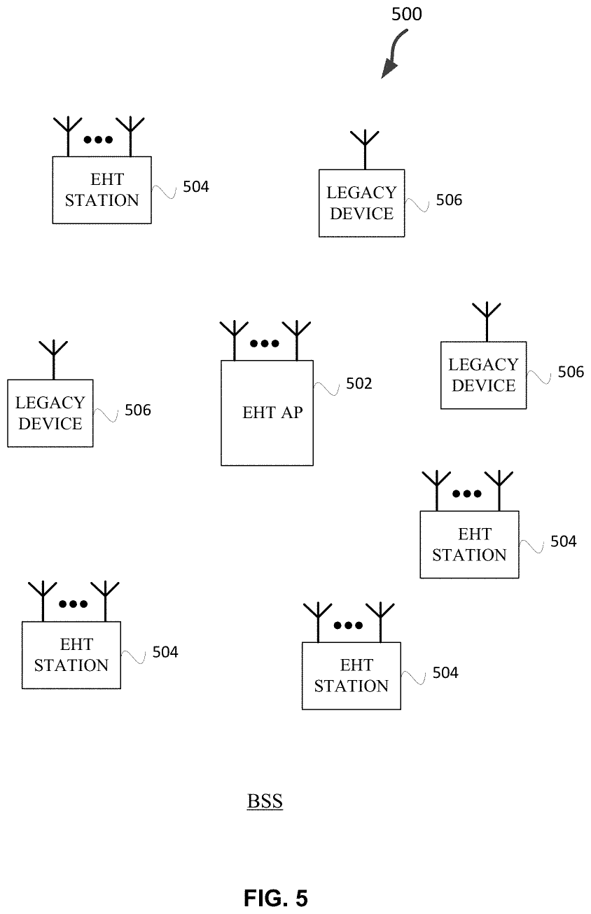

FIG. 5 illustrates a WLAN 500 in accordance with some embodiments. The WLAN 500 may comprise a basis service set (BSS) that may include an access point (AP) 502, which may be an AP, a plurality of stations 504, and a plurality of legacy (e.g., IEEE 802.11n/ac/ax) devices 506. In some embodiments, WLAN 500 may be configured for Extremely High Throughput (EHT) communications in accordance with the IEEE 802.11be standard and one or more stations including AP 502 may be EHT STAs. In some embodiments, WLAN 500 may be configured for next generation vehicle-to-everything (NGV) communications in accordance with the IEEE 802.11bd standard and one or more stations including AP 502 may be next generation vehicle-to-everything (NGV) stations (STAs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502. IEEE P802.11be/D2.0, May 2022 is incorporated herein by reference.

The legacy devices 506 may operate in accordance with one or more of IEEE 802.11 a/b/g/n/ac/ad/af/ah/aj/ay, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the STAs 504 may be termed high efficiency (HE) stations.

AP 502 may communicate with legacy devices 506 in accordance with legacy IEEE 802.11 communication techniques. In example embodiments, AP 502 may also be configured to communicate with STAs 504 in accordance with legacy IEEE 802.11 communication techniques.

In some embodiments, a frame may be configurable to have the same bandwidth as a channel. The frame may be a physical Layer Convergence Procedure (PLCP) Protocol Data Unit (PPDU). In some embodiments, there may be different types of PPDUs that may have different fields and different physical layers and/or different media access control (MAC) layers.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA PPDU formats. In some embodiments, the 106-subcarrier RU is used in the 20 MHz, 40 MHz, 80 MHz, 160 MHz and 80+80 MHz OFDMA and MU-MIMO PPDU formats. In some embodiments, the 242-subcarrier RU is used in the 40 MHz, 80 MHz, 160 MHz and 80+80 MHz OFDMA and MU-MIMO PPDU formats. In some embodiments, the 484-subcarrier RU is used in the 80 MHz, 160 MHz and 80+80 MHz OFDMA and MU-MIMO PPDU formats. In some embodiments, the 996-subcarrier RU is used in the 160 MHz and 80+80 MHz OFDMA and MU-MIMO PPDU formats.

A frame may be configured for transmitting a number of spatial streams, which may be in accordance with MU-MIMO and may be in accordance with OFDMA. In other embodiments, AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE and/or EHT communications. In accordance with some IEEE 802.11 embodiments (e.g., IEEE 802.11ax embodiments) a AP 502 may operate as a master station which may be arranged to contend for a wireless medium (e.g., during a contention period) to receive exclusive control of the medium for an control period. In some embodiments, the control period may be termed a transmission opportunity (TXOP). AP 502 may transmit a master-sync transmission, which may be a trigger frame or control and schedule transmission, at the beginning of the control period. AP 502 may transmit a time duration of TXOP and sub-channel information. During the control period, STAs 504 may communicate with AP 502 in accordance with a non-contention based multiple access technique such as OFDMA or MU-MIMO. This is unlike conventional WLAN communications in which devices communicate in accordance with a contention-based communication technique, rather than a multiple access technique. During the control period, the AP 502 may communicate with STAs 504 using one or more frames. During the control period, the STAs 504 may operate on a sub-channel smaller than the operating range of the AP 502. During the control period, legacy stations refrain from communicating. The legacy stations may need to receive the communication from the AP 502 to defer from communicating.

In accordance with some embodiments, during TXOP the STAs 504 may contend for the wireless medium with the legacy devices 506 being excluded from contending for the wireless medium during the master-sync transmission. In some embodiments the trigger frame may indicate an uplink (UL) UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy stations 506 and/or non-legacy stations 504 in accordance with legacy IEEE 802.11 communication techniques. In some embodiments, the AP 502 may also be configurable to communicate with STAs 504 outside the TXOP in accordance with legacy IEEE 802.11 communication techniques, although this is not a requirement.

In some embodiments station 504 may be a “group owner” (GO) for peer-to-peer modes of operation. A wireless device may be a Station 502 or a AP 502.

In some embodiments, the station 504 and/or AP 502 may be configured to operate in accordance with IEEE 802.11mc. In example embodiments, the radio architecture of FIG. 1 is configured to implement the station 504 and/or the AP 502. In example embodiments, the front-end module circuitry of FIG. 2 is configured to implement the station 504 and/or the AP 502. In example embodiments, the radio IC circuitry of FIG. 3 is configured to implement the station 504 and/or the AP 502. In example embodiments, the base-band processing circuitry of FIG. 4 is configured to implement the station 504 and/or the AP 502.

In example embodiments, the Stations 504, AP 502, an apparatus of the Stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the station 504 and/or the AP 502 are configured to perform the methods and operations/functions described herein. In example embodiments, an apparatus of the station 504 and/or an apparatus of the AP 502 are configured to perform the methods and functions described herein. The term Wi-Fi may refer to one or more of the IEEE 802.11 communication standards. AP and STA may refer to access point 502 and/or station 504 as well as legacy devices 506.

In some embodiments, a AP STA may refer to a AP 502 and a STAs 504 that is operating a APs 502. In some embodiments, when an STA 504 is not operating as a AP, it may be referred to as a non-AP STA or non-AP. In some embodiments, STA 504 may be referred to as either a AP STA or a non-AP.

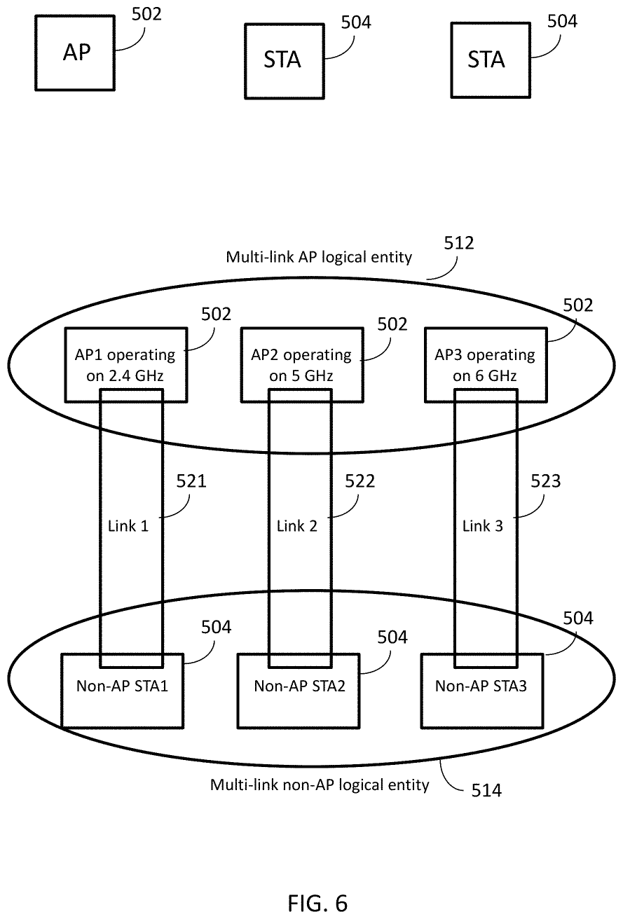

FIG. 6 illustrates a multi-link framework in accordance with some embodiments. The multi-link framework includes an access point (AP) multi-link device (AP MLD) 512 comprising a plurality of affiliated access point stations (AP STAs) 502 and a non-AP MLD 514 comprising a plurality of affiliated non-AP STAs 504. The AP MLD and the non-AP MLD may perform a multi-link setup procedure to set up the pairs of links 521, 522, 523 between the AP STAs 502 of the AP MLD 512 and corresponding non-AP STAs 504 of the non-AP MLD 514 to allow frames to be communicated between the non-AP MLD 514 and the AP MLD 512 using a single medium access control (MAC) service access point (SAP).

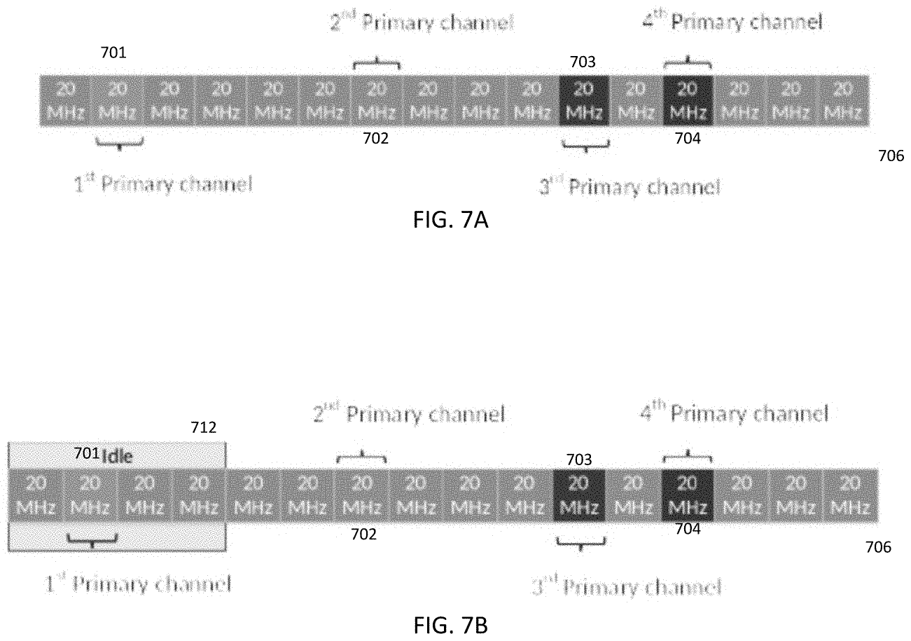

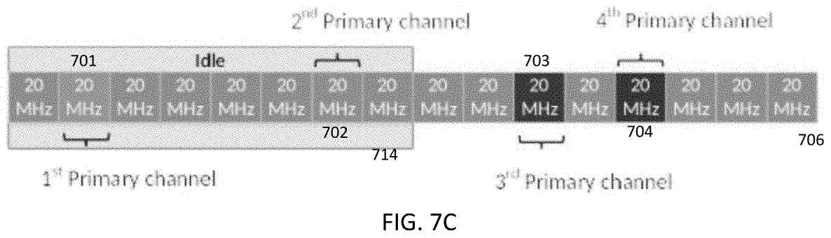

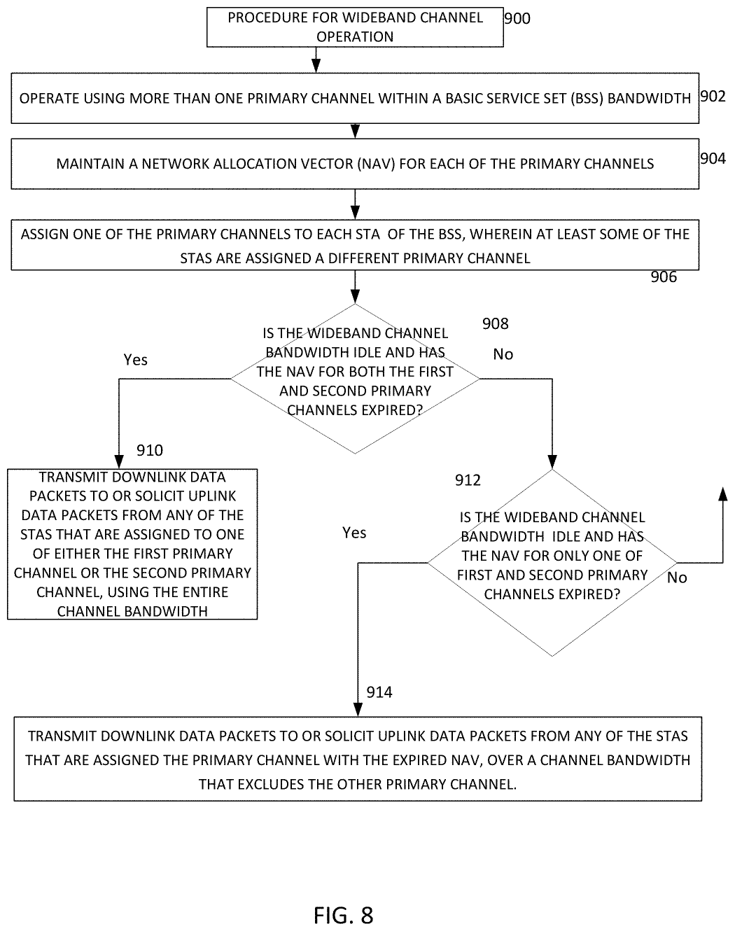

FIG. 7A, FIG. 7B and FIG. 7C illustrate wideband channel access in accordance with some embodiments. Although 802.11n/ac/ax/be support wideband transmissions such as 40/80/160/320 MHz transmissions, the transmission always needs to include the primary 20 MHz channel and if the primary 20 MHz channel is busy, a STA cannot transmit a wideband transmission and need to wait until the primary channel becomes idle. This degrades throughput. The next generation 802.11 standard, (i.e., IEEE 802.11bX), is expected to support 320 MHz channel bandwidth utilizing the 6 GHz band and if the same primary channel rule is used for the 320 MHz channel access, throughput degradation will be even worse and EHT may not utilize the full potential of the 320 MHz channel access.

In accordance with embodiments, the STAs are parking over different primary channels instead of switching between different temporary primary channels as in 802.11ax. As a result, it's easy for both of the STA and the AP to maintain and use the available channels for data transmission.

In the current draft standard IEEE 802.11be, for an AP with a single radio that is affiliated with an AP MLD, it can only have a single primary channel. As a result, the AP cannot access the channel if the primary channel is busy. Embodiments disclosed herein divide the total number of associated STAs (non-AP MLDs) into different groups and park them over different 20/40/80 MHz channels and enable the AP to have different primary channels with multiple Radios. As a result when any of the primary channel is available, AP can access the channel and communicate with the STAs parked over that primary channel.

In accordance with embodiments, different STAs are allocated different primary 20 MHz channels over the whole 320 MHz (or a larger bandwidth, e.g. 480 MHz or 640 MHz) channel to fully utilize wide bandwidth channel as follows: (1) Define more than one primary channels for the AP. An example is shown in FIG. 7A, where there are four primary channels 701, 702, 703 and 704 in a 320 MHz BSS bandwidth 706. Each 80 MHz bandwidth has one primary channel.

In this example, the number of primary channels over the 320 MHz bandwidth can be up to 16 (i.e. a STA can access any idle 20 MHz channel). The AP allocates a STA to one of the AP's primary channels as the STA's primary channel. An AP is enabled to transmit data on any idle channel(s), which includes any of the AP's primary channels (contiguous bandwidth). In FIG. 7A, when any of the four primary channels is idle, the AP can transmit data to a STA that has been assigned the idle primary channel over the idle channel bandwidth (e.g. 80 MHz). The AP is able to detect or decode packets on multiple channels including any of the primary channels within the 320 MHz channel simultaneously. As a result, when any channel bandwidth including any of the AP's primary channels over the 320 MHz channel bandwidth is idle, AP can schedule data transmission to the STAs that have been assigned the idle primary channels or transmit a trigger frame to solicit the STAs to send uplink data packet over the idle channel bandwidth, which includes the primary channel of the STAs.

In accordance with embodiments, an AP can access any idle channel, which includes any of its primary channels, to transmit downlink data or trigger uplink data transmission from the allocated STAs, therefore the AP is no longer restricted to the availability of the single primary channel and can enhance the overall network throughput.

Ap's Behavior:

When an AP supports 320 MHz (i.e. BSS bandwidth), it defines multiple primary channels over the whole 320 MHz bandwidth, which can be up to 16, for example. For 640 MHz bandwidth, the primary channels can be up to 32, for example. The AP is capable of sensing and decoding packets on multiple primary channels and updates NAV of each primary channel when a packet is received. The AP transmits a beacon and a group address frames on one of the primary channels. When a STA associates to the AP, the AP assigns the STA with one primary channel, which is selected from the AP's multiple primary channels.

Case 1) When a channel that includes only one of the AP's primary channels is idle, such as the first 80 MHz channel 712, which includes the AP's 1st primary channel, and the NAV of the 1st primary channel (e.g., primary channel 701) has expired, the AP may transmit downlink data packet to (or transmit a trigger frame to solicit an uplink data transmission from) the STAs that were allocated to AP's 1st primary channel. An example of this is illustrated in FIG. 7B.

Case 2) When a channel that includes more than one of the AP's primary channels are idle, such as the 1st 160 MHz channel 714, which includes the 1st and 2nd primary channels 701 and 702 and the NAV of the 1st and 2nd primary channels have expired, the AP can transmit downlink data packet or transmit a trigger frame to solicit uplink data transmission from the STAs that were allocated to the 1st or 2nd primary channel, over the 160 MHz channel, if the STAs support 160 MHz bandwidth (see FIG. 7C).

Case 3) When a channel that includes more than one of the AP's primary channels are idle, such as the 1st 160 MHz channel 714, which includes the 1st and 2nd primary channels 701 and 702 but the NAV of 1st primary channels haven't expired (only the 2nd primary channel's NAV has expired), the AP can i. Transmit downlink data packet or transmit a trigger frame to solicit uplink data transmission from the STAs that were allocated to the 2nd primary channel over the channel bandwidth excluding the 1st primary channel (see FIG. 7C). In these embodiments, the AP transmits a Trigger frame to solicit uplink transmissions from the STAs to prevent a STA from accessing the AP while the AP is transmitting to a STA on a channel including another primary channel.

STA's Behavior

When a STA associates to an AP that supports 320 MHz, the STA may indicate the primary channel that the STA wants to operate. During the association process, the AP may accept or reject the requested primary channel and indicates the allocated primary channel to the STA. The STA operates on the channel including the allocated primary channel afterwards for data transmission and reception. At a TBTT, a STA tunes to the primary channel that the AP is transmitting Beacon and any group addressed frames and returns back to the allocated primary channel. A STA listens to the allocated primary channel for data transmission from the AP. When a packet is detected on the channel including the allocated primary channel, the STA decodes the packet based on the bandwidth information indicated in the preamble of the packet. When a STA has data to transmit to the AP, the STA waits for a Trigger frame so that the STA doesn't transmit to the AP when the AP is transmitting to another STA on the channel including AP's another primary channel.

Some embodiments are directed to an access-point station (AP) 502 (see FIGS. 5 and 6) configured for wideband channel operation. In these embodiments, AP may operate using more than one primary channel (i.e., primary channels 701, 702, 703 and 704 (see FIGS. 7A-7C)) within a basic service set (BSS) bandwidth 706. In these embodiments, the AP may also maintain a network allocation vector (NAV) for each of the primary channels and assign or allocate one of the primary channels to each STA 504 of a plurality of stations (STAs) 504 of the BSS. At least some of the STAs are assigned a different primary channel. In these embodiments, the AP may communicate with the STAs over channel bandwidths that include one or more of the primary channels. For channel bandwidths that include more than one primary channel, the AP may communicate with the STAs within those channel bandwidths even though when the NAV of one of the primary channels within the channel bandwidth has not expired.

In these embodiments, for channel bandwidths that include only one (i.e., a single) primary channel, the AP may communicate with the STAs when the NAV of the primary channel has expired. In addition, for channel bandwidths that include more than one primary channel, the AP may communicate with the STAs even though the NAV of one of those primary channels has not expired. These embodiments are discussed in more detail below.

In some embodiments, for communicating over a channel bandwidth that includes only one of the primary channels (i.e., primary channel 701 within channel bandwidth 712) comprising a first primary channel, when the entire channel bandwidth 712 is idle (i.e., no energy detected in channel bandwidth 712) and when the NAV for the first primary channel has expired, the AP may transmit downlink data packets to or solicit uplink data packets from any of the STAs that are assigned to the first primary channel using the entire channel bandwidth 712. An example of this is illustrated in FIG. 7B in which only one of the primary channels is idle.

In some embodiments, for communicating over a channel bandwidth 714 that includes more than one of the primary channels (i.e., primary channels 701 and 702) including at least a first primary channel 701 and a second primary channel 702, when the entire channel bandwidth 714 is idle (i.e., no energy detected in channel bandwidth 714) and the NAV for both the first and second primary channels has expired, the AP may transmit downlink data packets to or solicit uplink data packets from any of the STAs that are assigned to one of either the first primary channel or the second primary channel, using the entire channel bandwidth 714. An example of this is illustrated in FIG. 7C in which more than one of the primary channels is idle.

In some embodiments, for communicating over a channel bandwidth 714 that includes more than one of the primary channels (i.e., primary channels 701 and 702) including at least a first primary channel 701 and a second primary channel 702, when the entire channel bandwidth 714 is idle (i.e., no energy detected in channel bandwidth 714), the NAV for the second primary channel has expired and the NAV for the first primary channel has not expired, the AP may transmit downlink data packets to or solicit uplink data packets from any of the STAs that are assigned the second primary channel, over a channel bandwidth that excludes the first primary channel. In these embodiments, since the NAV for the first primary channel has not expired, channel bandwidth 714 excluding the first primary channel 701 may be used for communicating. In these embodiments, the AP does not need to wait for the NAV of a primary channel to expire to transmit a wideband transmission when another primary channel is the channel bandwidth is available. An example of this is illustrated in FIG. 7C.

In some embodiments, for communicating over a channel bandwidth 714 that includes more than one of the primary channels (i.e., primary channels 701 and 702) including at least the first primary channel 701 and the second primary channel 702, when the entire channel bandwidth 714 is idle (i.e., no energy detected in channel bandwidth 714), the NAV for the second primary channel has expired and the NAV for the first primary channel has not expired, the AP may refrain from transmission of downlink data packets to or solicitation of uplink data packets over the entire channel bandwidth 714 from any of the STAs that are assigned the first primary channel as their primary channel.

In some embodiments, to solicit uplink data packets from one or more of the STAs, the AP may transmit a trigger frame over the channel bandwidth that excludes the first primary channel when the NAV for the second primary channel has expired and the NAV for the first primary channel has not expired.

In some embodiments, the AP may transmit beacon frames and group addressed frames in only one of the primary channels comprising a first primary channel 701. During a Target Beacon Transmission Time (TBTT), the STAs that are assigned to primary channels other than the first primary channel may be configured to tune to the first primary channel for receipt of any beacon frames and group addressed frames.

In some embodiments, each of the primary channels is a 20 MHz primary channel, although the scope of the embodiments is not limited in this respect. In some embodiments, the BSS bandwidth 706 comprises bandwidths of up to 320 MHz and in some embodiments up to 640 MHz, although the scope of the embodiments is not limited in this respect. In some embodiments, each 80 MHz bandwidth of the BSS bandwidth comprises only one primary channel, although the scope of the embodiments is not limited in this respect. In some embodiments, the channel bandwidths used for communication with the STAs comprise one or more of 20, 40 and 80 MHz bandwidths, although the scope of the embodiments is not limited in this respect.

In these embodiments, the channel bandwidths, which may comprise 20, 40 and 80 MHz bandwidths, are contiguous bandwidths. In these embodiments, for a BSS bandwidth of 320 MHz, the AP may operate using up to 16 primary channels, and for a BSS bandwidth of 640 MHz, the AP may operate using up to 32 primary channels (i.e., one primary channel in each 80 MHz block of continuous bandwidth), although the scope of the embodiments is not limited in this respect. In some embodiments, the AP and the STAs may be able to communicate over channel bandwidths greater than 80 MHz. In some embodiments, the AP may assign each of the STAs one of the primary channels when associating with the AP, although the scope of the embodiments is not limited in this respect.

In some embodiments, the AP may include processing circuitry that comprises a baseband processor and memory configured to store a status of the NAV for each of the primary channels. Some embodiments are directed to non-transitory computer-readable storage medium that stores instructions for execution by processing circuitry of a Access Point station (AP) configured for wideband channel operation.

Some embodiments are directed to non-Access Point Station (STA) configured for wideband channel operation. For wideband channel operation within a basic-service set (BSS) that uses more than one primary channel (i.e., primary channels 701, 702, 703 and 704) within a BSS bandwidth 706, the STA may receive an assignment one of the primary channels from an access point (AP) of the BSS. At least some of the STAs of the BSS are assigned a different primary channel. In these embodiments, the STA may communicate with the AP over a channel bandwidth (i.e., a wideband channel) that includes assigned the primary channel. For communicating over a channel bandwidth 714 that includes more than one of the primary channels (i.e., primary channels 701 and 702) including at least a first primary channel 701 and a second primary channel 702, when the entire channel bandwidth 714 is idle (i.e., no energy detected in channel bandwidth 714), and when the STA has been assigned the second primary channel as a primary channel, the STA may decode downlink data packets from the AP or a trigger frame from the AP that solicits uplink data packets from the STA over a channel bandwidth excluding the first primary channel. When the STA has been assigned the first primary channel as a primary channel, the STA may decode downlink data packets from the AP or a trigger frame from the AP that solicits uplink data packets from the STA over the channel bandwidth including the first primary channel.

In these embodiments, when the AP transmits beacon frames and group addressed frames in a first primary channel that is different than the STA's assigned primary channel, the STA may be configured to tune to the first primary channel for receipt of any beacon frames and group addressed frames. In these embodiments, the AP may transmit beacon frames and group addressed frames in only one of the primary channels comprising a first primary channel 701, which may not necessarily be the primary channel that is assigned to a station.

In some embodiments, a physical layer protocol data unit may be a physical layer conformance procedure (PLCP) protocol data unit (PPDU). In some embodiments, the AP and STAs may communicate in accordance with one of the IEEE 802.11 standards. IEEE 802.11-2016 is incorporated herein by reference. IEEE P802.11-REVmd/D2.4, August 2019, and IEEE draft specification IEEE P802.11ax/D5.0, October 2019 are incorporated herein by reference in their entireties. In some embodiments, the AP and STAs may be directional multi-gigabit (DMG) STAs or enhanced DMG (EDMG) STAs configured to communicate in accordance with IEEE 802.11ad standard or IEEE draft specification IEEE P802.11ay, February 2019, which is incorporated herein by reference.

In some embodiments, the mobile device may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The antennas may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the mobile device is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

FIG. 8 is a procedure 900 for wideband channel operation, in accordance with some embodiments. In operation 902, an access point may operate using more than one primary channel within a basic service set (BSS) bandwidth. In operation 904, the AP may maintain a network allocation vector (NAV) for each of the primary channels. In operation 906, the AP may assign one of the primary channels to each STA of the BSS. At least some of the STAs are assigned a different primary channel. In operation 908, the AP may determine if a wideband channel bandwidth idle and if the NAV for both the first and second primary channels expired.

When the wideband channel bandwidth is idle the NAV for both the first and second primary channels has expired, in operation 910, the AP may transmit downlink data packets to or solicit uplink data packets from any of the STAs that are assigned to one of either the first primary channel or the second primary channel, using the entire channel bandwidth.

In operation 912, the AP may determine if the wideband channel bandwidth idle and if the NAV for only one of first and second primary channels expired. When the wideband channel bandwidth is idle and the NAV for only one of first and second primary channels has expired, in operation 914, the AP may transmit downlink data packets to or solicit uplink data packets from any of the STAs that are assigned the primary channel with the expired NAV, over a channel bandwidth that excludes the other primary channel.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access-point station (AP) configured for wideband channel operation, the apparatus comprising: processing circuitry; and memory, wherein the processing circuitry is configured to:
operate using more than one primary channel within a basic service set (BSS) bandwidth;
maintain a network allocation vector (NAV) for each of the primary channels;
assign one of the primary channels to each STA of a plurality of stations (STAs) of the BSS, wherein at least some of the STAs are assigned a different primary channel;
communicate with the STAs over channel bandwidths that include one or more of the primary channels,
wherein for channel bandwidths that include more than one primary channel, the processing circuitry is to configure the AP for communicating with the STAs when the NAV of one of the primary channels has not expired.

2. The apparatus of claim 1, wherein for communicating over a channel bandwidth that includes only one of the primary channels comprising a first primary channel, and
wherein when the channel bandwidth is idle and when the NAV for the first primary channel has expired, the processing circuitry is configured to:
transmit downlink data packets to or solicit uplink data packets from any of the STAs that are assigned to the first primary channel using the channel bandwidth.

3. The apparatus of claim 2, wherein for communicating over a channel bandwidth that includes more than one of the primary channels including at least a first primary channel and a second primary channel, when the channel bandwidth is idle and the NAV for both the first and second primary channels has expired, the processing circuitry is configured to:
transmit downlink data packets to or solicit uplink data packets from any of the STAs that are assigned to one of either the first primary channel or the second primary channel, using the channel bandwidth.

4. The apparatus of claim 3, wherein for communicating over a channel bandwidth that includes more than one of the primary channels including at least a first primary channel and a second primary channel, when the channel bandwidth is idle, the NAV for the second primary channel has expired and the NAV for the first primary channel has not expired, the processing circuitry is configured to:
transmit downlink data packets to or solicit uplink data packets from any of the STAs that are assigned the second primary channel, over a channel bandwidth that excludes the first primary channel.

5. The apparatus of claim 4, wherein for communicating over a channel bandwidth that includes more than one of the primary channels including at least the first primary channel and the second primary channel, when the channel bandwidth is idle, the NAV for the second primary channel has expired and the NAV for the first primary channel has not expired, the processing circuitry is further configured to refrain from transmission of downlink data packets to or solicitation of uplink data packets over the channel bandwidth from any of the STAs that are assigned the first primary channel.

6. The apparatus of claim 4, wherein to solicit uplink data packets from one or more of the STAs, the processing circuitry is to configure the AP to transmit a trigger frame over the channel bandwidth that excludes the first primary channel when the NAV for the second primary channel has expired and the NAV for the first primary channel has not expired.

7. The apparatus of claim 4, wherein the processing circuitry is to further configure the AP to transmit beacon frames and group addressed frames in one of the primary channels comprising a first primary channel, and
wherein during a Target Beacon Transmission Time (TBTT), the STAs that are assigned to primary channels other than the first primary channel are configured to tune to the first primary channel for receipt of any beacon frames and group addressed frames.

8. The apparatus of claim 4, wherein each of the primary channels is a 20 MHz primary channel,
wherein the BSS bandwidth comprises bandwidths of up to 320 MHz,
wherein each 80 MHz bandwidth of the BSS bandwidth comprises one primary channel; and
wherein the channel bandwidths used for communication with the STAs comprise one or more of 20, 40 and 80 MHz bandwidths.

9. The apparatus of claim 8, wherein the processing circuitry is configured to assign each of the STAs one of the primary channels when associating with the AP.

10. The apparatus of claim 1, wherein the processing circuitry comprises a baseband processor, and wherein the memory is configured to store a status of the NAV for each of the primary channels.

11. A non-transitory computer-readable storage medium that stores instructions for execution by processing circuitry of a Access Point Station (AP) configured for wideband channel operation, the processing circuitry to:
operate using more than one primary channel within a basic service set (BSS) bandwidth;
maintain a network allocation vector (NAV) for each of the primary channels;
assign one of the primary channels to each STA of a plurality of stations (STAs) of the BSS, wherein at least some of the STAs are assigned a different primary channel;
communicate with the STAs over channel bandwidths that include one or more of the primary channels,
wherein for channel bandwidths that include more than one primary channel, the processing circuitry is to configure the AP for communicating with the STAs when the NAV of one of the primary channels has not expired.

12. The non-transitory computer-readable storage medium of claim 11, wherein for communicating over a channel bandwidth that includes only one of the primary channels comprising a first primary channel, and
wherein when the channel bandwidth is idle and when the NAV for the first primary channel has expired, the processing circuitry is configured to:
transmit downlink data packets to or solicit uplink data packets from any of the STAs that are assigned to the first primary channel using the channel bandwidth.

13. The non-transitory computer-readable storage medium of claim 12, wherein for communicating over a channel bandwidth that includes more than one of the primary channels including at least a first primary channel and a second primary channel, when the channel bandwidth is idle and the NAV for both the first and second primary channels has expired, the processing circuitry is configured to:
transmit downlink data packets to or solicit uplink data packets from any of the STAs that are assigned to one of either the first primary channel or the second primary channel, using the channel bandwidth.

14. The non-transitory computer-readable storage medium of claim 13, wherein for communicating over a channel bandwidth that includes more than one of the primary channels including at least a first primary channel and a second primary channel, when the channel bandwidth is idle, the NAV for the second primary channel has expired and the NAV for the first primary channel has not expired, the processing circuitry is configured to:
transmit downlink data packets to or solicit uplink data packets from any of the STAs that are assigned the second primary channel, over a channel bandwidth that excludes the first primary channel.

15. The non-transitory computer-readable storage medium of claim 14, wherein for communicating over a channel bandwidth that includes more than one of the primary channels including at least the first primary channel and the second primary channel, when the channel bandwidth is idle, the NAV for the second primary channel has expired and the NAV for the first primary channel has not expired, the processing circuitry is further configured to refrain from transmission of downlink data packets to or solicitation of uplink data packets over the channel bandwidth from any of the STAs that are assigned the first primary channel.

16. The non-transitory computer-readable storage medium of claim 14, wherein to solicit uplink data packets from one or more of the STAs, the processing circuitry is to configure the AP to transmit a trigger frame over the channel bandwidth that excludes the first primary channel when the NAV for the second primary channel has expired and the NAV for the first primary channel has not expired.

17. The non-transitory computer-readable storage medium of claim 14, wherein the processing circuitry is to further configure the AP to transmit beacon frames and group addressed frames in one of the primary channels comprising a first primary channel, and
wherein during a Target Beacon Transmission Time (TBTT), the STAs that are assigned to primary channels other than the first primary channel are configured to tune to the first primary channel for receipt of any beacon frames and group addressed frames.

18. An apparatus of a non-Access Point Station (STA) configured for wideband channel operation, the apparatus comprising: processing circuitry and memory, wherein for wideband channel operation within a basic-service set (BSS) that uses more than one primary channel within a BSS bandwidth, the processing circuitry is configured to:
receive an assignment one of the primary channels from an access point (AP) of the BSS, wherein at least some STAs of the BSS are assigned a different primary channel;
communicate with the AP over a channel bandwidth that includes assigned the primary channel,
wherein for communicating over a channel bandwidth that includes more than one of the primary channels including at least a first primary channel and a second primary channel, when the channel bandwidth is idle, the NAV for the second primary channel has expired and the NAV for the first primary channel has not expired, and
when the STA has been assigned the second primary channel as a primary channel, the processing circuitry is configured to decode downlink data packets from the AP or a trigger frame from the AP that solicits uplink data packets from the STA over a channel bandwidth excluding the first primary channel, and
when the STA has been assigned the first primary channel as a primary channel, the processing circuitry is configured to decode downlink data packets from the AP or a trigger frame from the AP that solicits uplink data packets from the STA over the channel bandwidth including the first primary channel.

19. The apparatus of claim 18, wherein when the AP transmits beacon frames and group addressed frames in a first primary channel that is different than the STA's assigned primary channel, the processing circuitry is configured to configure the STA to tune to the first primary channel for receipt of any beacon frames and group addressed frames.

20. The apparatus of claim 19, wherein each of the primary channels is a 20 MHz primary channel,
wherein the BSS bandwidth comprises bandwidths of up to 320 MHz,
wherein each 80 MHz bandwidth of the BSS bandwidth comprises one primary channel; and
wherein the channel bandwidths used for communication with STAs of the BSS comprise one or more of 20, 40 and 80 MHz bandwidths.
